(19) United States
(12) Patent Application Publication
(10) Pub. No.: US 2007/0003872 A1
(43) Pub. Date: Jan. 4, 2007

(54) Super resolution recording medium

(75) Inventors: Hyun-ki Kim, Hwaseong-si (KR); Moon-I Jung, Suwon-si (KR); Myong-do Ro, Yongin-si (KR); Joo-ho Kim, Yongin-si (KR); Nak-hyun Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/451,301

(22) Filed: Jun. 13, 2006

(30) Foreign Application Priority Data
Jun. 13, 2005 (KR) 2005-50479
Mar. 5, 2006 (KR) 2006-40117

(51) Int. Cl. G11B 7/24

(52) U.S. Cl. 430/270.11

(57) ABSTRACT

A super-resolution medium having a stable carrier-to-noise ratio (CNR) includes a control layer that controls a super-resolution aperture region of a projected optical spot where a super-resolution phenomenon occurs.

### CROSS-REFERENCE TO RELATED APPLICATIONS

This application claims the benefit of Korean Application Nos. 10-2005-0050497, filed on Jun. 13, 2005, and 10-2006-0040117, filed on May 3, 2006, in the Korean Intellectual Property Office, the disclosures of which are incorporated herein by reference.

### BACKGROUND OF THE INVENTION

1. Field of the Invention

Aspects of the present invention relate to a super resolution medium, and more particularly, to a super resolution medium which obtains a stable carrier to noise ratio (CNR) by improving signal characteristics.

2. Description of the Related Art

Optical discs are roughly classified into a magneto-optical type, a phase-change type, and a pit-forming type according to the way in which data is recorded. Phase-change type optical discs are recording media which use variations in optical characteristics, such as, a refraction rate or a reflection rate between amorphous and crystalline portions of the discs. Phase-change type optical discs record data by generating a reversible change in portions of the discs between an amorphous state and a crystal state by projecting laser light onto a recording layer formed of a phase-change material. More specifically, phase-change optical discs record data by changing the crystalline state of a recording layer material, which is a non-recorded state, into an amorphous state, which is a recorded state, by melting portions of the recording layer material with laser light and then cooling the melted portion of the recording layer material quickly. To erase the recorded data on the discs, laser light of a lower power than the laser light that is applied upon data recording is radiated on the recording layer so that the portions of the recording layer in an amorphous state are changed to a crystalline state.

As demand increases for a new medium having higher recording density, development of the next-generation of information recording media has been attempted based on new technology.

However, increasing the recording density of the medium has limitations. When the wavelength of a light source used for reproducing data from an optical medium is λ, and the number of apertures of an objective lens is NA, then λ/4NA is a reproduction resolving power limit of the light source. In other words, due to such a reproduction resolving power limit, data cannot be reproduced even when sizes of recording marks are minimized. In other words, data cannot be reproduced from a medium when light radiated from a light source cannot detect recording marks that are smaller than the reproduction resolving power limit of λ/4NA.

To overcome the reproduction resolving power limit of λ/4NA, recording media of a super resolution near-field structure type (super-RENS) have been studied of late. Such super-resolution recording media have met some of the need for higher density and higher capacity recording media because even small recording marks that deviate from, or are below, the resolving power limit of a light source can be reproduced from the super-resolution recording media.

In this regard, FIG. 1 illustrates a conventional super-RENS medium 10. Referring to FIG. 1, the conventional super-RENS medium 10 includes a substrate 11, a first dielectric layer 12, a first phase change layer 13, a second dielectric layer 14, a recording layer 15, a third dielectric layer 16, a second phase change layer 17, a fourth dielectric layer 18, and a cover layer 19. The first dielectric layer 12, the first phase change layer 13, the second dielectric layer 14, the recording layer 15, the third dielectric layer 16, the second phase change layer 17, the fourth dielectric layer 18, and the cover layer 19 are sequentially formed on the substrate 11. The first, second, third, and fourth dielectric layers 12, 14, 16, and 18 serve as heat sinks and are formed of a zinc sulfide-silicon dioxide (ZnS—SiO₂) compound, silicon oxide (SiOₓ), silicon nitride (SiNₓ), or the like. The first, second, third, and fourth dielectric layers 12, 14, 16, and 18 are optional. Even when the first, second, third, and fourth dielectric layers 12, 14, 16, and 18 are not included, data can still be reproduced from conventional super-RENS medium 10. The first and second phase change layers 13 and 17 help the recording of recording marks to the recording layer 15. The recording layer 15 may be formed of a metal oxide or a polymer compound. For example, the recording layer 15 is formed of a metal oxide comprising at least one of gold oxide (AuOₓ), palladium oxide (PdOₓ), platinum oxide (PtOₓ), and silver oxide (AgOₓ). C₃₂H₁₈N₈,H₂PC (Phthalocyanine) may be used as the polymer compound.

Data is reproduced from the recording layer 15 of the conventional super-RENS medium 10 by a reproducing beam that is incident upon the substrate 11 from below or above the substrate 11 via an objective lens (not shown) and passed through the substrate 11. More specifically, it has been reported that recording marks smaller than the resolving power limit can be reproduced due to a signal amplification effect (hereinafter, referred to as a super-resolution phenomenon) caused by an interaction between the reproducing beam and the metal particles of the recording layer 15, that is, by a surface plasmon resonance.

FIG. 2 illustrates a conventional super-resolution medium 20 having a three-layered structure made up of a super-resolution phase change reproducing layer and dielectric layers. Referring to FIG. 2, the conventional super-resolution medium 20 includes a substrate 21, a first dielectric layer 22, a super-resolution recording layer 23, and a second dielectric layer 24. The first dielectric layer 22, the super-resolution recording layer 23, and the second dielectric layer 24 are sequentially formed on the substrate 21. The super-resolution recording layer 23 comprises phase change materials.

When a phase change layer is used in a super-resolution medium as a reproducing layer in which the super-resolution phenomenon occurs, the phase change layer has different reproducing characteristics from those of phase change layers included in general phase-change discs or non-super-resolution recording media.

The following explains some differences between general phase-change discs or non-super-resolution recording media, and super-resolution recording media. In general phase-change discs, amorphous recording marks are formed in a phase change layer as a recording layer, and data is reproduced from the recording marks by using a difference between reflectivities of the amorphous portions and the crystalline portions of the recording layer. To record data to the recording layer formed of a general phase change material, the recording layer is melted and rapidly cooled, so that portions of the recording layer become amorphous. The amorphous portions of the recording layer become recording marks.

During data erasure of such general phase-change discs, the amorphous portions are heated by a light source so that they are melted and then slowly cooled so that the amorphous portions become stably crystalline. To achieve this result in the general phase change discs, the amorphous recording marks are heated to a temperature equal to or greater than a glass-transition temperature, whereby they are removed. When erasing the recording marks in the general phase change discs, light having a higher power level than a light having a reproducing power level is used as light having an erasure power level. Therefore, a reproducing beam used to reproduce data from such a general phase-change medium uses a reproducing power level that does not change the crystal state of the recording marks.

In contrast, however, the reproducing beam used in a super-resolution medium 20 of FIG. 2 is a beam of light having a higher power level than that of the reproducing beam used in the general phase-change medium, In a such case, a threshold level of reproducing power at which a carrier to noise ratio (CNR) rapidly increases becomes exceeded.

FIGS. 3 and 4 are graphs showing a CNR versus the reproducing power of a conventional super-resolution medium. Referring to FIG. 3, in the conventional super-resolution medium, the CNR increases rapidly with an increase in the reproducing power of the reproducing beam between a range of about 1.4 mW to about 1.8 mW, then rapidly decreases once the power level exceeds a predetermined power level at about 1.8mW. As seen in FIG. 3, the CNR is at its high values within a small marginal range of reproducing power between about 1.5 mW and about 1.8 mW. Referring to FIG. 4, a super-resolution aperture (labeled C1 and C2) is produced by an optical spot S projected onto a super-resolution recording layer of the conventional super-resolution medium. Therein, the rapid decrease of the CNR above the reproducing power value of 1.8 mW in FIG. 3 can be seen as being due to an increase in the size of a super-resolution aperture from C1 to C2 corresponding to an increase in the reproducing power of the reproducing beam. The rapid decrease of the CNR degrades a super-resolution reproducing signal from the super-resolution medium. Thus, as a conventional super-resolution medium provides only a small margin for controlling the reproducing power output of the reproducing beam, it accordingly causes difficulty in controlling the reproducing power output.

### SUMMARY OF THE INVENTION

Additional aspects and/or advantages of the invention will be set forth in part in the description which follows and, in part, will be obvious from the description, or may be learned by practice of the invention.

Aspects of the present invention provide a super-resolution medium with an increased margin for controlling the reproducing power applicable to the problem in which the CNR increases with an increase in the reproducing power of the reproducing beam, then rapidly decreases when the reproducing power of the reproducing beam is at or greater than a predetermined power during reproduction of data from the super-resolution medium.

According to an aspect of the present invention, there is provided a super-resolution medium including: a substrate; a super-resolution layer to allow a super-resolution phenomenon to occur, the super-resolution phenomenon being a phenomenon allowing data to be reproduced from marks on the super-resolution layer with sizes less than or equal to a resolving power limit of a beam, and which occurs when a super-resolution aperture region of an incident optical spot of the beam causes a temperature distribution change or an optical characteristic change in the super-resolution layer; and a super-resolution aperture control layer to keep the super-resolution aperture region constant.

According to another aspect of the present invention, there is provided a super-resolution medium including: a substrate; a first dielectric layer formed on the substrate; a super-resolution layer formed on the first dielectric layer to allow a super-resolution phenomenon to occur, the super-resolution phenomenon being a phenomenon allowing data to be reproduced from marks on the super-resolution layer with sizes less than or equal to a resolving power limit of a beam, and which occurs when a super-resolution aperture region of an incident optical spot of the beam causes a temperature distribution change or an optical characteristic change in the super-resolution layer; a second dielectric layer formed on the super-resolution layer; and a super-resolution aperture control layer formed on the second dielectric layer to keep the super-resolution aperture region constant.

According to another aspect of the present invention, there is provided a super-resolution medium including: a substrate; a super-resolution aperture control layer formed on the substrate to keep constant a super-resolution aperture region of an incident optical spot of a beam where a temperature distribution change or an optical characteristic change occurs; a first dielectric layer formed on the super-resolution aperture control layer; a super-resolution layer formed on the first dielectric layer, in which the super-resolution aperture region causes a super-resolution phenomenon in which data can be reproduced from marks with sizes less than or equal to a resolving power limit of the beam; and a second dielectric layer formed on the super-resolution layer.

According to another aspect of the present invention, there is provided a super-resolution medium, including a substrate, a super-resolution layer formed over the substrate and having a first thickness, and a super-resolution aperture control layer formed over the substrate and having a second thickness, wherein the first and second thicknesses are determined so as to control a size of a super-resolution aperture formed on the super-resolution layer.

According to another aspect of the present invention, there is provided a system for recording and/or reproducing data to and/or from a super-resolution medium having a substrate, a super-resolution layer, and a super-resolution aperture control layer, including an apparatus, having a pickup unit, a recording and/or reproducing signal processing unit, and a controller, to record and/or reproduce data to and/or from the super-resolution medium, wherein a reproducing beam from the apparatus has a wavelength that results in controlling a size of a super-resolution aperture formed on the super-resolution layer.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional super-resolution medium;

FIG. 2 illustrates a conventional super-resolution medium having a three-layered structure that is made up of a super-resolution phase change reproducing layer and dielectric layers;

FIGS. 3 and 4 are graphs showing a carrier to noise ratio (CNR) versus the reproducing power of a conventional super-resolution medium;

FIG. 5 is a cross-section of a super-resolution medium according to an embodiment of the present invention;

FIGS. 6 and 7 are views illustrating a region of the super-resolution medium of FIG. 5 whose optical characteristics change during super-resolution reproduction;

FIG. 8 is a cross-section of a super-resolution medium according to another embodiment of the present invention;

FIG. 9 is a graph showing a signal characteristic versus the reproducing power of a super-resolution medium including a super-resolution aperture control layer according to the present invention; and

FIG. 10 is a schematic diagram of an apparatus for recording data to or reproducing data from a super-resolution medium according to the present invention.

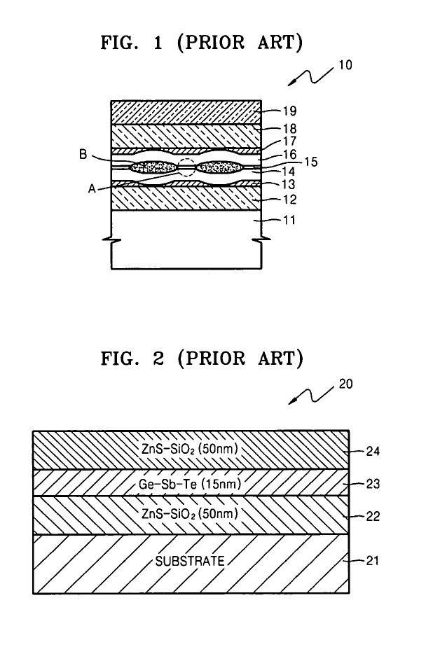

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A reason why a CNR rapidly decreases with an increase of the reproducing power of a conventional super-resolution layer is that when a reproducing beam having higher power than a reproducing beam used in a general phase-change medium is used, a heat sink is generated and a super-resolution aperture that enables data to be reproduced from small recording marks equal to or smaller than a resolving power limit becomes enlarged. The super-resolution aperture is defined as a region of an optical spot radiated during super-resolution reproduction where a super-resolution phenomenon occurs. The super-resolution phenomenon enables reproduction of data from the small recording marks that are equal to or smaller than the resolving power limit of a reproducing beam due to generation of a temperature distribution change or an optical characteristic change in a super-resolution medium. An aspect of the present invention provides a super-resolution medium providing a stable CNR over a wider range of reproducing power by including a super-resolution aperture control layer which can control the super-resolution aperture to be kept constant.

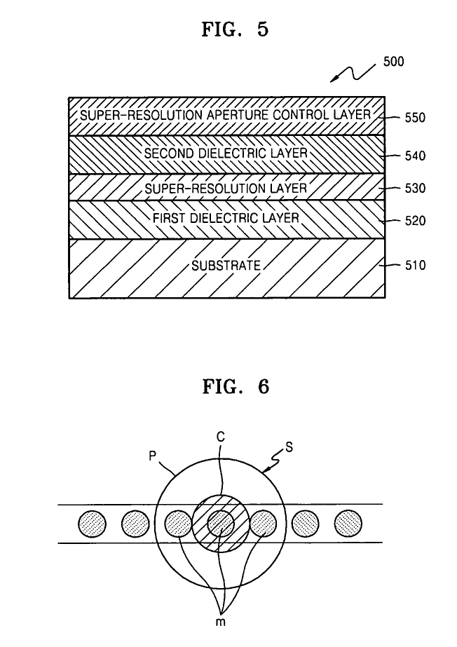

FIG. 5 is a cross-section of a super-resolution medium 500 according to an embodiment of the present invention. Referring to FIG. 5, the super-resolution medium 500 includes a substrate 510, a first dielectric layer 520, a super-resolution layer 530 which is a phase change layer where a super-resolution phenomenon occurs, a second dielectric layer 540, and a super-resolution aperture control layer 550. According to the embodiment of FIG. 5, the first dielectric layer 520, the super-resolution layer 530, the second dielectric layer 540, and the super-resolution aperture control layer 550 are sequentially formed on the substrate 510. The first and second dielectric layers 520 and 540, serving as thermal and/or mechanical protection layers, are optional. Even when the first and second dielectric layers 520 and 540 are not included, data reproduction is possible. When a super resolution phenomenon occurs due to a change of the refractive index of a portion of a beam, data is reproduced from the super-resolution layer 530.

The substrate 510 is made of any known material or may be any later developed material suitable for use as a substrate of a super-resolution medium. The substrate 510 includes one of polycarbonate, polymethymethacrylate (PMMA), amorphous polyolefin (APO), and glass, or any combination thereof.

The first and second dielectric layers 520 and 540, serving as thermal and/or mechanical protection layers, are made of at least one of oxide, nitride, carbide, fluoride, and sulfide. For example, each of the first and second dielectric layers 520 and 540 is made of at least one of silicon oxide (SiOx), magnesium oxide (MgOx), aluminum oxide (AlOx), titanium oxide (TiOx), vanadium oxide (VOx), chromium oxide (CrOx), nickel oxide (NiOx), zirconium oxide (ZrOx), germanium oxide (GeOx), zinc oxide (ZnOx), silicon nitride (SiNx), aluminum nitride (AINx), titanium nitride (TiNx), zirconium nitride (ZrNx), germanium nitride (GeNx), silicon carbide (SiC), zinc sulfide (ZnS), a zinc sulfide-silicon dioxide compound (ZnS—SiO₂), and magnesium fluoride (MgF₂), or any combination thereof. When each of the first and second dielectric layers 520 and 540 is made of ZnS—SiO₂, it can obtain the best signal characteristics when the mole ratio of ZnS to SiO₂ is 8:2.

According to an aspect of the embodiment shown in FIG. 5, the thickness of the various layers of the super-resolution medium 500 is prescribed. For example, according to the embodiment shown in FIG. 5, each of the first and second dielectric layers 520 and 540 is about 50 nm. However, the thicknesses of the first and second dielectric layers 520 and 540 need not be the same but may be different. Generally, when each of the first and second dielectric layers 520 and 540 is less than or equal to about 50 nm thick, desirable signal characteristics are obtained. The super-resolution layer 530 may be between about 10 nm to about 50 nm. According to the aspect of the embodiment shown in FIG. 5, the thickness is about 15 nm. Generally, when the super-resolution layer 530 is less than or equal to 20 nm, desirable signal characteristics are obtained. Nevertheless, the thickness thereof may vary according to various factors, such as the wavelength of a light source (not shown) and the required refractive index of the super-resolution layer 530.

According to the aspect of the embodiment shown in FIG. 5, the super-resolution layer 530 is made of a germanium-antimony-tellurium (Ge—Sb—Te)-base or silver-indium-antimony-tellurium (Ag—In—Sb—Te)-base phase-change material. For example, the super-resolution layer 530 may be formed of 6.5% of Ge, 72.5% of Sb, and 21% of Te. Data is reproduced from the super-resolution medium 500 by a reproducing beam that is incident upon the substrate 510 from above or below the substrate 510 via an objective lens and which passes through the substrate 510.

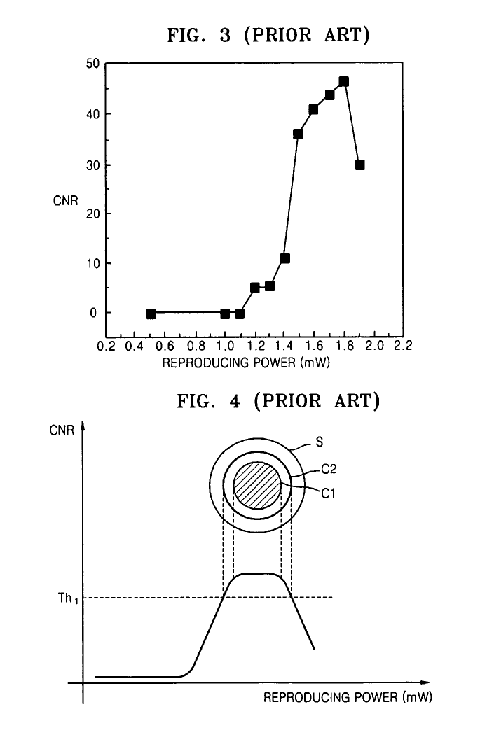

According to the aspect of the embodiment shown in FIG. 5, the super-resolution medium 500 includes the super-resolution aperture control layer 550 having a heat sink function in order to control thermal accumulation. The super-resolution aperture control layer 550 discharges heat that is accumulated during radiation of the reproducing beam, so that the size of the super-resolution aperture is kept in a predetermined range. To improve the heat sink efficiency, the super-resolution aperture control layer 550 may be formed of a material having high thermal conductivity. For example, the super-resolution aperture control layer has a higher thermal conductivity than that of the super-resolution layer. The super-resolution aperture control layer 550 may be formed of at least one of Pt, Ag, Pd, Au, and Al, or any combination thereof. The thickness of the super-resolution aperture control layer may be any thickness needed, or desired. The super-resolution aperture control layer lessens the thermal accumulation that occurs with an increase in the reproducing power that leads to an enlargement of the super-resolution aperture, and the degradation of super-resolution control in a conventional super-resolution medium, as discussed above with reference to FIGS. 3 and 4.

According to the embodiment shown in FIG. 5, the various thickness of each of the various layers are controlled so as to control a size of a super-resolution aperture formed on the super-resolution layer, and/or provide a stable CNR over a wider range of reproducing power. When controlled, the super-resolution aperture may be kept at a constant size.

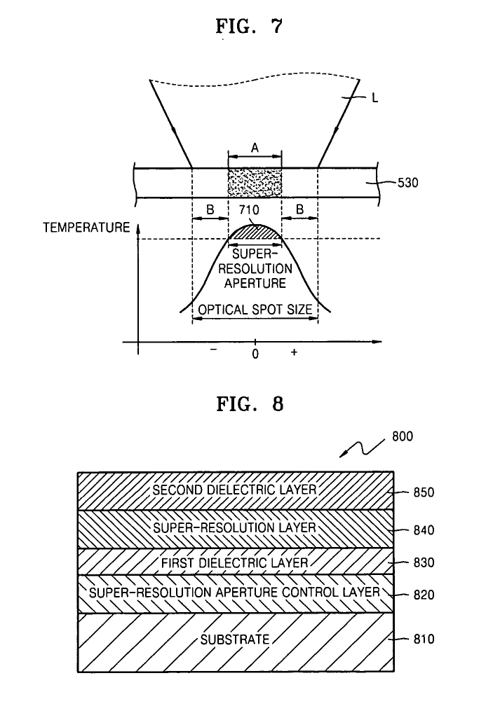

FIGS. 6 and 7 are views illustrating a region of the super-resolution medium 500 of FIG. 5 whose optical characteristics change during super-resolution reproduction. Referring to FIG. 6, a temperature distribution change or an optical characteristic change occurs in a hatched region C of an optical spot S radiated on the super-resolution medium 500 during super-resolution reproduction. No temperature distribution changes or optical characteristic changes occur on the peripheral region P. The hatched region C corresponds to a super-resolution aperture. The super-resolution aperture may be the center region of the optical spot S, or rear region of the optical spot S (e.g., a region other than the center region). In the super-resolution aperture region, a temperature distribution change or an optical characteristic change occurs due to a difference in the partial optical strength of a reproducing beam. The super-resolution aperture region enables data to be reproduced from marks m that have sizes exceeding the resolving power limit.

Referring to FIG. 7, when a laser beam L is radiated onto the super resolution layer 530, an optical spot formed on the super resolution layer 530 has a Gaussian temperature distribution in which the temperature is the highest at the center of the super-resolution aperture region and decreases away from the center, according to the intensity distribution of a laser beam, and leads to a temperature distribution change in the super-resolution layer. In the embodiment shown in FIG. 7, the center region A of the optical spot corresponds to a super-resolution aperture region and has a higher temperature than that of the other peripheral region B. The peripheral region B corresponds to the peripheral region P of FIG. 6 and has a lower temperature than that of the center region A. Within the central region A, a particular temperature of the super resolution layer is exceeded (shown as 710). Due to this temperature difference, an optical characteristic change occurs in the center region A corresponding to the super-resolution aperture with respect to region B, or other regions, so that reproduction of recording marks that exceed the resolving power limit is possible.

FIG. 8 is a cross-section of a super-resolution medium 800 according to another embodiment of the present invention. Referring to FIG. 8, the super-resolution medium 800 includes a substrate 810, a super-resolution aperture control layer 820, a first dielectric layer 830, a super-resolution layer 840, and a second dielectric layer 850. The super-resolution aperture control layer 820, the first dielectric layer 830, the super-resolution layer 840, and the second dielectric layer 850 are sequentially formed on the substrate 810 in this aspect of the present invention. However, the first and second dielectric layers 830 and 850 may be omitted if desired. The super-resolution medium 800 performs the same operation and has the same characteristics as the super-resolution medium 500 except that the super-resolution aperture control layer 820 is formed on the substrate 810 so that the super-resolution layer 840 is formed over the super-resolution aperture control layer 820. In other aspects of the present invention, the super-resolution layer 840 may be formed to directly contact the super-resolution aperture control layer 820. Meanwhile, the super-resolution aperture control layer 820 may be inserted into the super-resolution layer 840 so as to control thermal accumulation that is generated in the super-resolution layer.

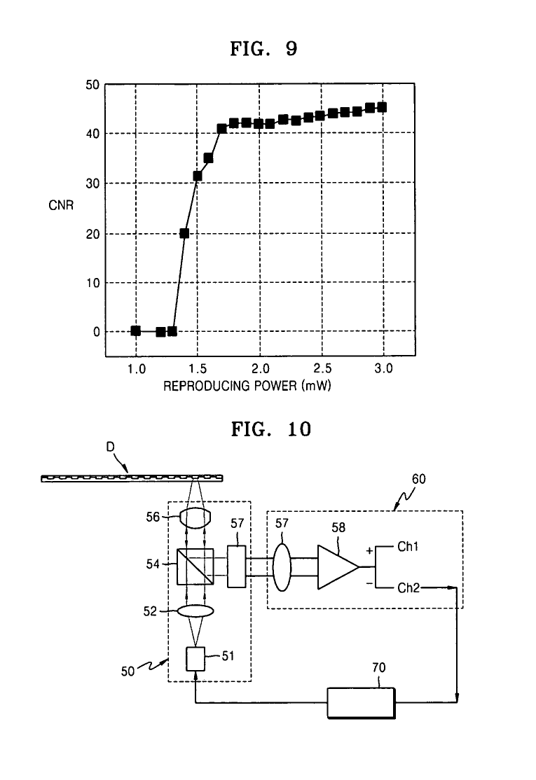

FIG. 9 is a graph showing a signal characteristic versus the reproducing power of a super-resolution medium including a super-resolution aperture control layer according to the present invention. An optical system having a reproducing beam of a 659 nm wavelength and a numerical aperture of 0.6 was used and measured the CNR of data reproduced from a single recording mark whose size is less than or equal to the resolving power limit of 173 nm.

Referring to FIG. 9, in the super-resolution medium according to aspects of the present invention, the CNR rapidly increases as reproducing power increase between a range of about 1.3 mW to about 1.7 mW and is kept above 40 dB at about 47 dB without a rapid decrease during an increase in the reproducing power between a range of about 1.7 mW to about 3.0 mW. Hence, the super-resolution medium according to this aspect of the present invention provides a high quality signal having an RF waveform and displays a higher reproducing power margin than that of a conventional super-resolution medium that has no super-resolution aperture control layers.

FIG. 10 is a schematic diagram of an apparatus for recording data to or reproducing data from a super-resolution medium D according to an aspect of the present invention. Referring to FIG. 10, the apparatus includes a pickup unit 50, a recording/reproducing signal processing unit 60, and a controller 70. The pickup unit 50 includes a laser diode 51 for radiating light, a collimating lens 52 for collimating the light radiated by the laser diode 51, a beam splitter 54 for changing the path of incident light, and an objective lens 56 for focusing the light passed through the beam splitter 54 on the super-resolution medium D.

Light reflected by the super-resolution medium D is again reflected by the beam splitter 54 and received by a photodetector, for example, a quadrant photodetector 57. The light received by the quadrant photodetector 57 is converted into an electrical signal by an operation circuit portion 58, thereby outputting an RF signal. The controller 70 controls a recording/reproducing beam having power equal to or more than required power to be radiated via the optical pickup unit 50 in order to form recording marks whose sizes are equal to or smaller than the resolving power limit. The required power can be determined according to the characteristics of the super-resolution medium D.

Since the CNR of the super-resolution medium D is stabilized by a super-resolution aperture control layer, the reproducing characteristics are excellent even when data is repeatedly reproduced from the super-resolution medium D, and a reproducing signal is stably detected.

As described above, when data is reproduced from a super-resolution medium according to the present invention, the problem in which the CNR increasing with an increase in the reproducing power is rapidly decreased when the reproducing power is at or greater than predetermined power is lessened, so that a margin for the reproducing power is improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A super-resolution medium comprising:
a substrate;
a super-resolution layer to allow a super-resolution phenomenon to occur, the super-resolution phenomenon being a phenomenon allowing data to be reproduced from marks on the super-resolution layer with sizes less than or equal to a resolving power limit of a beam, and which occurs when a super-resolution aperture region of an incident optical spot of the beam causes a temperature distribution change or an optical characteristic change in the super-resolution layer; and
a super-resolution aperture control layer to keep the super-resolution aperture region constant.

2. The super-resolution medium of claim 1, wherein the super-resolution aperture control layer controls thermal accumulation that is generated by the incident optical spot.

3. The super-resolution medium of claim 1, wherein super-resolution aperture control layer is formed of a material having high thermal conductivity so as to keep the super-resolution aperture region constant.

4. The super-resolution medium of claim 1, wherein the super-resolution aperture control layer is formed of at least one of Pt, Ag, Pd, Au, and Al.

5. The super-resolution medium of claim 1, wherein the super-resolution aperture control layer is formed at one area of the inside, the upper surface, and the lower surface of the super-resolution layer.

6. The super-resolution medium of claim 1, further comprising at least one dielectric layer formed over the substrate.

7. The super-resolution medium of claim 1, wherein the dielectric layer is formed of at least one of oxide, nitride, carbide, fluoride, and sulfide.

8. The super-resolution medium of claim 7, wherein the dielectric layer is formed of at least one of silicon oxide (SiOx), magnesium oxide (MgOx), aluminum oxide (AlOx), titanium oxide (TiOx), vanadium oxide (VOx), chromium oxide (CrOx), nickel oxide (NiOx), zirconium oxide (ZrOx), germanium oxide (GeOx), zinc oxide (ZnOx), silicon nitride (SiNx), aluminum nitride (AINx), titanium nitride (TiNx), zirconium nitride (ZrNx), germanium nitride (GeNx), silicon carbide (SiC), zinc sulfide (ZnS), a zinc sulfide-silicon dioxide compound (ZnS—SiO₂), and magnesium fluoride (MgF₂).

9. The super-resolution medium of claim 1, wherein the super-resolution layer is formed of a phase-change material.

10. The super-resolution medium of claim 9, wherein the super-resolution layer is formed of one of a germanium-antimony-tellurium (Ge—Sb—Te)-base phase-change material and silver-indium-antimony-tellurium (Ag—In—Sb—Te)-base phase-change material.

11. The super-resolution medium of claim 1, wherein the super-resolution layer is formed over the substrate and the super-resolution aperture control layer is formed over the super-resolution layer.

12. The super-resolution medium of claim 11, further comprising at least one dielectric layer formed between the super-resolution layer and the substrate and between the super-resolution aperture control layer and the super-resolution layer.

13. The super-resolution medium of claim 1, wherein the super-resolution aperture control layer is formed over substrate and the super-resolution layer is formed over the super-resolution aperture control layer.

14. The super-resolution medium of claim 13, further comprising at least one dielectric layer formed between the super-resolution aperture control layer and the substrate and the super-resolution layer and the super-resolution aperture control layer.

15. A super-resolution medium comprising:
a substrate;
a first dielectric layer formed on the substrate;
a super-resolution layer formed on the first dielectric layer to allow a super-resolution phenomenon to occur, the super-resolution phenomenon being a phenomenon allowing data to be reproduced from marks on the super-resolution layer with sizes less than or equal to a resolving power limit of a beam, and which occurs when a super-resolution aperture region of an incident optical spot of the beam causes a temperature distribution change or an optical characteristic change in the super-resolution layer;
a second dielectric layer formed on the super-resolution layer; and
a super-resolution aperture control layer formed on the second dielectric layer to keep the super-resolution aperture region constant.

16. The super-resolution medium of claim 15, wherein the super-resolution aperture control layer is formed of a material having high thermal conductivity so as to control thermal accumulation that is generated by the incident optical spot.

17. A super-resolution medium comprising:
a substrate;
a super-resolution aperture control layer formed on the substrate to keep constant a super-resolution aperture region of an incident optical spot of a beam where a temperature distribution change or an optical characteristic change occurs;
a first dielectric layer formed on the super-resolution aperture control layer;
a super-resolution layer formed on the first dielectric layer, in which the super-resolution aperture region causes a super-resolution phenomenon in which data can be reproduced from marks with sizes less than or equal to a resolving power limit of the beam; and
a second dielectric layer formed on the super-resolution layer.

18. The super-resolution medium of claim 17, wherein the super-resolution aperture control layer is formed of a material having a higher thermal conductivity than that of the super-resolution layer so as to control thermal accumulation that is generated by the incident optical spot.

19. The super-resolution medium of claim 1, wherein the super-resolution aperture control layer is inserted into the super-resolution layer so as to control thermal accumulation that is generated in the super-resolution layer.

20. The super-resolution medium of claim 3, wherein the thermal conductivity of the super-resolution aperture control layer is higher than that of the super-resolution layer.

21. The super-resolution medium of claim 16, wherein the thermal conductivity of the super-resolution aperture control layer is higher than that of the super-resolution layer.

22. A system for recording and/or reproducing data to and/or from a super-resolution medium having a substrate, a super-resolution layer, and a super-resolution aperture control layer, comprising:
an apparatus, having a pickup unit, a recording and/or reproducing signal processing unit, and a controller, to record and/or reproduce data to and/or from the super-resolution medium, wherein a reproducing beam from the apparatus has a wavelength that results in controlling a size of a super-resolution aperture formed on the super-resolution layer.

23. The system of claim 22, wherein the super-resolution layer results in stabilizing a CNR of the super-resolution medium.

24. The system of claim 22, wherein the wavelength is about 659 nm.

25. The system of claim 22, wherein a size of the super-resolution aperture is constant.
